(19) United States
(12) Patent Application Publication
(10) Pub. No.: US 2022/0215185 A1
(43) Pub. Date: Jul. 7, 2022

(54) METHOD AND SYSTEM FOR FACILITATING SEQUENCE-TO-SEQUENCE TRANSLATION

(71) Applicant: Armand Prieditis, MCKINLEYVILLE, CA (US)

(72) Inventor: Armand Prieditis, MCKINLEYVILLE, CA (US)

(73) Assignee: Armand Prieditis, MCKINLEYVILLE, CA (US)

(21) Appl. No.: 17/140,516

(22) Filed: Jan. 4, 2021

(51) Int. Cl. G06F 40/58; G06F 40/51; G06N 20/00

(52) U.S. Cl. CPC G06F 40/58; G06N 20/00; G06F 40/51

(57) ABSTRACT

During operation, embodiments of the subject matter can perform sequence to sequence translation. Inputs can comprise a sequence of elements in one language and outputs can comprise a sequence of elements in another language, where the number of elements in the input sequence might not match the number of elements in the output sequence. Unlike in encoder-decoder approaches to sequence-to-sequence transformations, embodiments of the subject matter can use Dynamic Programming to facilitate efficient sequence to sequence translation. Unlike in Deep Learning, embodiments of the subject matter cannot be fooled by spurious correlations because they do not require an unsupervised learning step.

### BACKGROUND

### Field

The subject matter relates to sequence-to-sequence translation.

### Related Art

Sequence-to-sequence (seq2seq) translation involves translating a sequence of symbols from one language to a sequence of symbols in another language. For example, the sequence of symbols in the first language might be a sentence in English and the sequence of symbols in the second language might be a sentence in German.

Two problems make seq2seq translation challenging. The first problem is that the sequence order in one language might not be preserved in the other language. For example, one language might comprise sentences of the form Subject-Verb-Object and the other language might comprise sentences of the form Object-Subject-Verb. Because Object comes last in the first sentence and first in the second sentence, this translation might require passing information from distant parts of the sentence.

The second problem is that the number of symbols in the first sequence might not be equal to the number of symbols in the second sequence. For example, a single German word (e.g., apfelkuchen) can translate to multiple words in English (e.g., apple cake).

The most prominent approach to seq2seq translation involves using encoder-decoders typically coupled with deep neural networks. In this approach the input sequence is encoded through a stack of recurrent neural network units, each of which receives a single element of the input sequence, determines a “hidden” state, and then propagates that “hidden” state to the next unit, which, in turn, similarly processes the next part of the input sequence. This continues until the input sequence is used up and a final “hidden” state is reached in the encoder. Typically, the final “hidden” state also produces a “context” vector.

Both the final “hidden” state and “context” vector are fed into a decoder, which uses a stack of recurrent neural network units to produce each output in sequence. As with the encoder, each recurrent unit receives a “hidden” state from the previous unit and produces an output as well as another ‘hidden” state. The sequence of outputs is the translation.

Encoder-decoder methods have several advantages. First, they can facilitate producing an output sequence that differs in length from the input sequence. This is because the encoder encodes an input sequence into a final “hidden” state and the “context” vector, which can then be decoded into an output sequence that might differ in length from the input sequence. Another advantage of encoder-decoders is that they are machine learnable from data.

Encoder-decoder methods have several disadvantages. First, Deep Learning, which they typically use, can result in discovered features that are uncorrelated to the target. This is because Deep Learning comprises an initial unsupervised learning step, which can be fooled by features uncorrelated to the target. Second, information can be lost in translation because the final “hidden” state and “context” vector are fixed in length, whereas the input sequence is not. In fact, the larger the size ratio between input sequence and the “hidden” state and “context” vector, the more information can be lost in translation.

As a result, “attention” mechanisms were developed to solve the “fixed-length” problem by allowing each input location its own “context” vector. During translation, the most relevant “context” vector for a particular target word is determined. Such “attention” mechanisms are used in Google's Transformer, BERT, GPT-1, GPT-2, and GPT-3. Unfortunately, information can still be lost in translation because any one context vector is still fixed in length. Moreover, and as with encoder-decoders, it is difficult to determine the right output length.

Hidden Markov Models (HMMs) are an alternative to encoder-decoder methods. Rather than relying on a context vector to propagate information from one part of a sequence to another as in “attention” mechanisms, HMMs propagate information through hidden states that can change with each element of the sequence. HMMs have been applied to natural language processing, speech recognition, machine maintenance, acoustics, biosciences, handwriting analysis, text recognition, gene sequencing, intrusion detection, gesture recognition, and image processing.

HNMs have several advantages. First, and unlike encoder-decoder approaches, HMMs can use Dynamic Programming for efficiency. Second, the information propagation through states can be made systematically more accurate by increasing the order of the HMMs. For example, basing the transition on the last two states instead of just the last state can improve HMM performance though at the risk of decreasing the amount of available training data. Third, HMMs do not require the accoutrements of Deep Learning, such as convolution, defining stride lengths, and pooling. Fourth, like encoder-decoders, HMMs are machine learnable from data.

Despite these advantages, HMMs they were not designed to handle input-output sequence pairs, especially of different lengths. In contrast, Dynamic Time Warping (DTW) methods were precisely designed to handle input-output sequence pairs of different lengths. More precisely, DTW can find a least number of insertions, deletions, and substitutions that can transform an input sequence to an output sequence. Like HMMs, DTW can use Dynamic Programming to facilitate efficiently finding the transformations through caching and re-use.

However, DTW is not generative: it cannot be used to find an output sequence given an input sequence. It merely finds the transformations that convert a given input to a given output. Moreover, the distance functions that DTW uses were not design to be machine learnable.

Hence, what is needed is a method and a system for seq2seq translation that is generative and machine learnable, that does not rely on fixed-length intermediate representations of encoder-decoders, that is efficient through Dynamic Programming as in HMMs, and that can handle input-output pairs of differing lengths as in Dynamic Time Warping.

### SUMMARY

One embodiment of the subject matter can facilitate seq2seq translation by combining HMMs with DTW and optimization. For convenience of notation, we call this embodiment Generative Dynamic Time Warping (GDTW).

GDTW has several advantages over previous approaches. First and unlike DTW, GDTW is generative: given an input, it can generate an output of a potentially different length. Second, GDTW loses less information in translation than encoder-decoders because it does not rely on fixed-length “context” vectors for translation. Third and unlike HMMs, GDTW's transition function from one state to another is also based on the previous input and output, which can make GDTW more accurate.

Fourth and unlike DTW, GDTW can be machine learned from examples comprising input and output sequences, thus eliminating the expense of manual programming. Fifth and unlike Deep Learning, GDTW can't be fooled by discovering features in the input that are uncorrelated to the output. This is because GDTW takes into account the entire output when choosing each step in translation.

Sixth and like HMMs but unlike encoder-decoders, GDTW can leverage Dynamic Programming for efficiency. Moreover, GDTW is parallelizable in two ways during machine learning.

One way in which GDTW is parallelable is that it can employ multiple random restarts, which will be described later, which can be run in parallel. The other way in which GDTW is parallelizable is by determining a model's statistics in parallel on one or more rows and then combining those statistics. For example, 100 million rows of training data can be used to update a model in 100 parallel batches of a million rows. The details of training and updates will also be described later.

Embodiments of the subject matter can be applied to several different use cases beyond language translation. For example, embodiments of the subject matter can be applied to Predicting Splicing from a Primary Sequence of Nucleotides. The input sequence can comprise a sequence of nucleotides and the corresponding output sequence can comprise a categorical variable that indicates whether the position in the sequence is a splice acceptor, splice donor, or neither. That is, each nucleotide in the sequence can be a splice acceptor, splice donor, or neither.

Embodiments of the subject matter can also be applied to Noise Removal. For example, the input can comprise a waveform with both the signal and the noise and the output can comprise only the signal. This embodiment can be trained on input examples comprising a particular person's voice in a cocktail party (signal+noise) and corresponding output examples comprising only the particular person's voice (signal). During prediction, embodiments of the subject matter can extract only the person's voice during cocktail party noise comprising other conversations. Embodiments of the subject matter can learn to extract any signal from a variety of noisy sources including but not limited to airplane noise, fan noise, traffic noise, wind noise, chainsaw noise, water noise, white noise, and pink noise.

Embodiments of the subject matter can also be applied to several other uses cases including but not limited to Sentiment Analysis (the input is a sequence of words and the output is a single sentiment, which can be positive, negative, or neutral), Natural Language Relationships (finding a relationship between two sequences as one of entailment, neutrality, or contradiction), Role (given a sentence, answer determine the subject, object, and time frames), Relation Extraction (given a sentence, determine relationships between objects and subjects), Pronoun Resolution (given a sentence identify who a pronoun is referring to), Language Translation (translate from one natural language to another), Speech Recognition (determine the sequence of words from an audio waveform), Speech Synthesis (determine the audio waveform from the sequence of words), Video Captioning (given image or video, determine a sentence that characterizes he image or video), Text Summarization (given one or more sentences, summarize those sentences into a single phrase), and News Headline Generation (summarize a news story with a headline).

The details of one or more embodiments of the subject matter are set forth in the accompanying drawings and the description below. Other features, aspects, and advantages of the subject matter will become apparent from the description, the drawings, and the claims.

### BRIEF DESCRIPTION OF THE FIGURES

FIG. 1 presents an example system for facilitating seq2seq translation.

In the FIGURES, like reference numerals refer to the same FIGURE elements.

### DETAILED DESCRIPTION

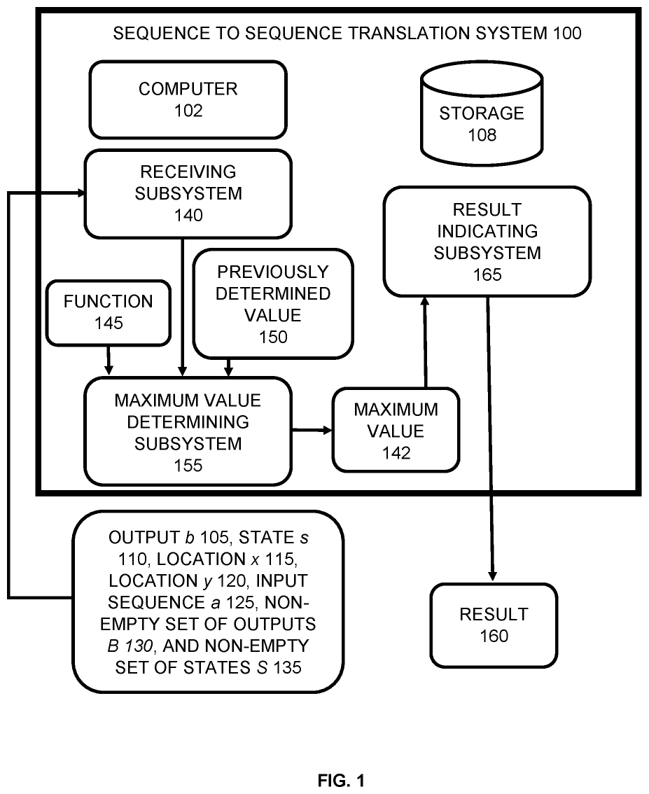

FIG. 1 shows an example seq2seq translation system 100 in accordance with an embodiment of the subject matter. Seq2seq translation system 100 is an example of a system implemented as a computer program on one or more computers in one or more locations (shown collectively as computer 102), with one or more storage devices (shown collectively as storage 108), in which the systems, components, and techniques described below can be implemented.

During operation, seq2seq translation system 100 receives an output b 105, state s 110, location x 115, location y 120, input sequence a 125, non-empty set of outputs B 130, and non-empty set of states S 135 with receiving subsystem 140. The output b 105 can be one or more categorical variable values (values that can be organized into non-numerical categories), one or more continuous variable values (values for which arithmetic operations are applicable), or one or more ordinal variable values (values which have a natural order, such as integers). Similarly, the state s 105 can be one or more categorical variable values, one or more continuous variable values, or one or more ordinal variable values. The location x 115 corresponds to the location of an input in the input sequence a and the location y 120 corresponds to the location of an output. More specifically, y serves as a limiting counter for the number of elements in the output sequence: the output sequence is not explicitly modeled as in the input sequence, but is generated one element at a time. The input sequence a 125 corresponds to a sequence of input variable values, each of which can be one or more categorical variable values, one or more continuous variable values, or one or more ordinal variable values.

Each element of the non-empty set of outputs B 130 corresponds to one or more categorical variable values, one or more continuous variable values, or one or more ordinal variable values. Each element of the non-empty set of states S 135 corresponds to one or more categorical variable values, one or more continuous variable values, or one or more ordinal variable values

Next, seq2seq translation system 100 determines a maximum value 142 over each element b′ in B and each element s′ in S based on a function 145 of aₓ, b, s, aₓ₋₁, b′, s′ and a previously determined value 150 based on b′, s′, x−1, and y−1 with maximum value determining subsystem 155. The elements b′ and s′ associated with the maximum value 142 correspond to the most likely output and state respectively for location x−1 in the input sequence and location y−1 in the output sequence.

The maximum value 142 over each element b′ in B and each element s′ in S can be additionally based on a function of aₓ, b, s, b′, s′ and a previously determined value based on b′, s′, x, and y−1. The maximum value 142 can be additionally determined over each element s′ in S based on a function of aₓ, b, s, aₓ₋₁, s′ and a previously determined value based on b, s′, x−1, and y.

Subsequently, seq2seq translation system 100 returns a result 160 that indicates the maximum value 140 with resulting indicating subsystem 165.

These embodiments can be used to determine T[b, s, x, y], as defined below, for all input symbols b, states s, location x, and location y. Here the brackets [ ] in T[b, s, x, y] refer to 4-dimensional array that can be precomputed and cached for values of b, s, x, and y. In these embodiments, Dynamic Programming can be used to determine T[b, s, x, y] by precomputing T[b, s, x, y] from low to high values of x and y and for all values of b and s.

More specifically, Dynamic Programming can be used to determine T[b, s, x, y] because T[b, s, x, y] can be based on T[b, s′, x−1, y], T[b′, s′, x, y−1], and T[b′, s′, x−1, y−1], all of which can be precomputed and stored because either x is decremented or y is decremented or both x and y are decremented. The previously determined value 150 corresponds to T[b′, s′, x−1, y−1].

$$T [ b , s , x , y ] = \{ \begin{matrix}c ( {a}_{x} , b , s ) & x = y = 0 \\ {max}_{{{b}^{′} ∈ B}_{{s}^{′} ∈ S}} \{ d ( {a}_{x} , b , s \vert {b}^{′} , {s}^{′} ) T [ {b}^{′} , {s}^{′} , x , y - 1 ] \} & x = 0 \\ {max}_{{s}^{′} ∈ S} \{ e ( {a}_{x} , b , s \vert {a}_{x - 1} , {s}^{′} ) T [ b , {s}^{′} , x - 1 , y ] \} & y = 0 \\ max ( \begin{matrix}{max}_{{{b}^{′} ∈ B}_{{s}^{′} ∈ S}} \{ d ( {a}_{x} , b , s \vert {b}^{′} , {s}^{′} ) T [ {b}^{′} , {s}^{′} , x , y - 1 ] \} \\ {max}_{{s}^{′} ∈ S} \{ e ( {a}_{x} , b , s \vert {a}_{x - 1} , {s}^{′} ) T [ b , {s}^{′} , x - 1 , y ] \} \\ {max}_{{{b}^{′} ∈ B}_{{s}^{′} ∈ S}} \{ f ( {a}_{x} , b , s \vert {a}_{x - 1} , {b}^{′} , {s}^{′} ) T [ {b}^{′} , {s}^{′} , x - 1 , y - 1 ] \}\end{matrix} ) & otherwise\end{matrix}$$

Here, c(aₓ, b, s) refers to the probability of an input aₓ, output b, and state s. This probability can be represented as a three-dimensional lookup table (one dimension each for the input, the output, and state). It can also be defined as c(b|aₓ, s)c(aₓ|s)c(s), where c(b|aₓ, s) refers to the probability of b conditioned on aₓ, s, c(aₓ|s) refers to the probability of aₓ conditioned on s, and c(s) refers to the probability of s. Multiple other methods can be used to define c(aₓ, b, s).

The function d(aₓ, b, s|b′, s′) refers to the probability of an input aₓ, output b, and state s conditioned on an output b′ and state s′. Note that unlike in an HMM, which models a state transition as spontaneous from one state s′ to another state s, the function d(aₓ, b, s|b′, s′) comprises a more sophisticated “transition” function—one that is not spontaneous—based on more than just s and s′.

When x=y=0, the first element of both the input and output sequences has been reached. Note in embodiments of the subject matter, the output sequence in Tis not explicitly modeled as a sequence. Instead, each element of the output sequence is returned as a tuple and the entire sequence can be determined by unwinding the returned values of T. This unwinding will also be described shortly. Subsequent conditions in the definition assume that conditions above have not been met. For example, for the condition x=0, it is assumed that both x and y are not zero.

When x=0, the first element of the input sequence has been reached but not in the output sequence. The function d(aₓ, b, s|b′, s′) refers to the probability of aₓ, b, and s conditioned on b′ and s′. This is multiplied by T[b′, s′, x, y−1].

When y=0, the first element of the output sequence has been reached and the output sequence remains on the last element of the output sequence, which is b. The function e(aₓ, b, s|aₓ₋₁, s′) refers to the probability of an input aₓ, output b, and state s conditioned on an output aₓ₋₁ and state s′. Note that since b remains the same, it does not appear on the right hand side of the conditional. The function e(aₓ, b, s|aₓ₋₁, s′) is multiplied by T[b, s′, x−1, y].

The otherwise condition returns a max of three items. The first item is just like the x=0 case: only they is decremented. The second item is just like the y=0 case: only the x is decremented. In the last item, both the x and they are decremented. In the last item, f(aₓ, b, s|aₓ₋₁, b′, s′) refers to the probability of an input aₓ, output b, and state s conditioned on an output aₓ₋₁, b′, and state s′. This is multiplied by T[b′, s′, x−1, y−1].

Note that product operations in T can be transformed into sums by applying the log to all functions, changing the products to a sums, and changing the max to a negative min. This transformation is mathematically equivalent to the original, but can be faster to compute because of the sums instead of the products.

Embodiments of the subject matter can determine the output as shown below. Line 1 sets the initial value for x and y to be m and n, respectively. Here m refers to the length of the input sequence and n refers to the length of the output sequence. Methods that can be used to choose the length of the output sequence n will be described later.

Line 2 sets the initial value of b and s to be the most likely values of b′ and s′, respectively, within the argmax. Line 3 sets the output array z at location y to be the current (last) output value. The output array z contains the current output values in order, but these are assigned to z in reverse order.

Line 4 is a loop is entered only if both x>0 and y>0. Lines 5-18 determine which of the three items in the max of the otherwise clause in T are the largest and record the associated output values. In particular lines 5-7 set variables R1, R2, and R3 because they are re-used several times. Line 8 tests if the first item in the max of the otherwise clause in Tis the largest. If so, line 9 finds the most likely values of b′ and s′ and sets them to b and s, respectively. Line 10 decrements they value and sets z[y] to be the current output. Line 12 test if the second item in the max of the otherwise clause in Tis the largest. If so, If so, line 9 finds the most likely value of s′ and sets it to be s. The value of b is not set because it remains the same. Similarly, the output z is not set because it remains the same as the previous one. However, x is decremented. Lines 16-18 handle the last item in the max of the otherwise clause in T, which is the largest at this point. These lines set b and s to the most likely values of b′ and s′ in the argmax, decrement both x and y, and set z[y] to the b. The while loop in line 4 exits when either y=0 or x=0 or both are true. Line 19 will loop while y>0 and set values similarly to lines 9-11. No loop is required for x>0 at this point because at that pointy must be zero and no new output values will be generated.

Embodiments of the subject matter can use multiple different methods to determine the output values; below we describe one such method as representative of retracing the computation involved for T to recover the output values.

| | |
|---|---|
| 1. | (x,y) = (m,n) |
| 2. | (b,s) = argmax{T[b′,s′,x,y]\|b′ in B and s′ in S} |
| 3. | z[y] = b |
| 4. | while (y > 0) and (x > 0) do: |
| 5. | R1 = max{d(aₓ,b,s,\|b′,s′)T[b′,s′,x,y−1]\|b′ in B and s′ in |
| | S} |
| 6. | R2 = max{e(aₓ,b,s\|aₓ₋₁,s′)T[b,s′,x−1,y]\|s′ in S} |
| 7. | R3 = max{f(aₓ,b,s,\|aₓ₋₁,b′,s′)T[b′,s′,x−1,y−1]\|b′ in B and |
| | s′ in S} |
| 8. | if (R1 > R2) and (R1 > R3): |
| 9. | (b,s) = argmax{d(aₓ,b,s,\|b′,s′)T[b′,s′,x,y-1]\|b′ in B and |
| | s′ in S} |
| 10. | y = y−1 |
| 11. | z[y] = b |
| 12. | else-if (R2 > R1) and (R2 > R3): |
| 13. | s = argmax{e(aₓ,b,s\|aₓ₋₁,s′)T[b,s′,x−1,y]\|s′ in S} |
| 14. | x = x−1 |
| 15. | else: |
| 16. | (b,s) = argmax{f(aₓ,b,s,\|aₓ−1,b′,s′)T[b′,s′,x−1,y−1]\|b′ in |
| | B and s′ in S} |
| 17. | (x,y) = (x−1,y−1) |
| 18. | z[y] = b |
| 19. | while (y > 0) do: |
| 20. | (b,s) = argmax{d(aₓ,b,s\|b′,s′)T[b′,s′,x,y−1]\|b′ in B and |
| | s′ in S} |
| 21. | y = y−1 |
| 22. | z[y] = b |

Typically, the length m of the output sequence will not be known a priori. Also, a smaller value of m is more probable because the probabilities are multiplied in T. For example, even though the German “applekuchen” translates to two English words “apple cake,” the probability of “cake” by itself is higher than “apple cake” because of the multiplier effect of probabilities. Embodiments of the subject matter can determine an appropriate m by exploring values of m from high to low and terminating the exploration when an inflection point (i.e., an elbow point) is reached in T. At this elbow point the probability Twill get lower still, but with diminishing returns.

Embodiments of the subject matter can be used to learn the probability functions c, d, e, and f from training data comprising input and output sequences based on the function V below.

$$V [ s , x , y ] = \{ \begin{matrix}c ( {a}_{x} , {b}_{y} , s ) & x = y = 0 \\ {max}_{{s}^{′} ∈ S} \{ d ( {a}_{x} , {b}_{y} , s \vert {b}_{y - 1} , {s}^{′} ) V [ {s}^{′} , x , y - 1 ] \} & x = 0 \\ {max}_{{s}^{′} ∈ S} \{ e ( {a}_{x} , {b}_{y} , s \vert {a}_{x - 1} , {s}^{′} ) V [ {s}^{′} , x - 1 , y ] \} & y = 0 \\ max ( \begin{matrix}{max}_{{s}^{′} ∈ S} \{ d ( {a}_{x} , {b}_{y} , s \vert {b}_{y - 1} , {s}^{′} ) V [ {s}^{′} , x , y - 1 ] \} \\ {max}_{{s}^{′} ∈ S} \{ e ( {a}_{x} , {b}_{y} , s \vert {a}_{x - 1} , {s}^{′} ) V [ {s}^{′} , x - 1 , y ] \} \\ {max}_{{s}^{′} ∈ S} \{ f ( {a}_{x} , {b}_{y} , s \vert {a}_{x - 1} , {b}_{y - 1} , {s}^{′} ) V [ {s}^{′} , x - 1 , y - 1 ] \}\end{matrix} ) & otherwise\end{matrix}$$

During operation, embodiments of the subject matter can generate initial probability functions c(a, b, s), d(a, b, s|b′, s′), e(a, b, s|a′, s′), and f(a, b, s|a′, b′, s′) and then use these functions to determine state values for each element of each row in the training data. Here and for simplicity of presentation, a is used to refer to an element of an input sequence and not the input sequence itself and a′ is used to refer to the predecessor element in the sequence. Embodiments of the subject matter equivalently apply to sequences in reverse (or any) order, provided the location appropriately reflects the ordering.

For example, the parameters of the initial probability functions can be randomly chosen. Once the state values can be determined for each element of each row, these probability functions can be updated and the cycle can repeat until convergence.

Convergence can be defined in multiple ways. For example, convergence can be defined in terms of number of iterations. Convergence can be defined in terms of changes to the model (e.g., minimal changes signals convergence). Convergence can also be defined in terms of a likelihood function over the training data or an reserved data set reaching a maximum. This likelihood function will be described later.

Given these probability functions, embodiments of the subject matter can determine V for all states s∈S for all x: 0≤x≤m and for all y: 0≤y≤n for each training row and its respective m and n. Once V is determined, embodiments of the subject matter can determine a most likely sequence of states for each row. In turn, these states can be used to determine updated probability functions c(a, b, s), d(a, b, s|b′, s′), e(a, b, s|a′, s′), and f(a, b, s|a′, b′, s′) based on the sequence of (determined) states, (actual) inputs, and (actual) outputs for each row.

Lines 1-30 below are similar to finding the outputs, except here the both the inputs and outputs are known for each row and the objective is to generate data from which c(a, b, s), d(a, b, s|b′, s′), e(a, b, s|a′, s′), and f(a, b, s|a′, b′, s′) can be updated. Note that these lines executed for each row with its associated inputs, outputs, and m and n values. Note also that c(a, b, s), d(a, b, s|b′, s′), e(a, b, s|a′, s′), and f(a, b, s|a′, b′, s′) can be updated after all the rows have been processed with lines 1-30.

Lines 1-2 set the initial x, y, and s values. Lines 4-18, which are only executed when both x and y are greater than zero, generate appropriate data for updating each of the respective probability functions c, d, e, and f. For example, line 10 adds b_{y-1}, s′→aₓ, b_{y}, s to data for the update of probability function d. This means that this b_{y-1}, s′ is added to data that can be used to determine the probability of the triple aₓ, b_{y}, s. Lines 14 and 18 add data for the e and f functions to be updated.

Once the loop for line 3 exits, either x or y or both are zero. If only y is zero, line 20 is executed. If only x is zero, line 25 is executed. After both of these loops exit, line 30 is executed and the data that can be used to determine the probability functions c, d, e, and f is complete for the particular row in the training data that has been processed. The remaining rows are similarly processed.

| | |
|---|---|
| 1. | (x,y) = (m,n) |
| 2. | s = argmax{V[s′,x,y]\| s′ in S} |
| 3. | while (x > 0) and (y > 0) do: |
| 4. | R1 = max{d(aₓ,b_{y},s,\|b_{y-1},s′)V[s′,x,y−1]\| s′ in S} |
| 5. | R2 = max{e(aₓ,b_{y},s\|aₓ₋₁,s′)V[s′,x−1,y]\|s′ in S} |
| 6. | R3 = max{f(aₓ, b_{y},s,\|aₓ₋₁, b_{y-1},s′)V[s′,x−1,y−1]\| s′ in S } |
| 7. | if (R1 > R2) and (R1 > R3): |
| 8. | s′ = argmax{d(aₓ,b_{y},s,\| b_{y}−1,s′)V[s′,x,y−1]\|s′ in S} |
| 9. | y = y−1 |
| 10. | add b_{y-1},s′ → aₓ,b_{y},s to data for d update |
| 11. | else-if (R2 > R1) and (R2 > R3): |
| 12. | s′ = argmax{e(aₓ,b_{y},s\|aₓ₋₁,s′)V[s′,x−1,y]\|s′ in S} |
| 13. | x = x−1 |
| 14. | add aₓ₋₁,s′ → aₓ,b_{y},s to data for e update |
| 15. | else: |
| 16. | s′ = argmax{f(aₓ,b_{y},s\|aₓ₋₁,b_{y-1},s′)V[s′,x−1,y−1]\|s′ in S} |
| 17. | (x,y) = (x−1,y−1) |
| 18. | add aₓ₋₁,b_{y-1},s′ → aₓ,b_{y},s to data for f update |
| 19. | s = s′ |
| 20. | while (x > 0) do: |
| 21. | s′ = argmax{e(aₓ,b_{y},s\|aₓ₋₁,s′)V[s′,x−1,y]\|s′ in S} |
| 22. | x = x−1 |
| 23. | add aₓ₋₁,s′ → aₓ,b_{y},s to data for e update |
| 24. | s = s′ |
| 25. | while (y > 0) do: |
| 26. | s′ = argmax{d(aₓ,b_{y},s\| b_{y-1},s′)V[s′,x,y−1]\|s′ in S} |
| 27. | y = y−1 |
| 28. | add b_{y-1},s′ → aₓ,b_{y},s to data for d update |
| 29. | s = s′ |
| 30. | add aₓ,b_{y},s to training examples for c |

The likelihood of the training set given the probability functions c, d, e, and f is the product of max{V[s′m, n]|s′ in S} over each row's respective m, n and input and output sequences. Other equivalent methods can be used to determine the likelihood, including log-likelihood, which transforms the products into sums everywhere and applies a log transformation to the probability functions c, d, e, and f.

The updates to the functions c, d, e, and f can be based on data and hence any machine learning method can be used to update the functions including but not limited to conditional probability tables, neural networks, and decision trees. A machine learning method in the context of embodiments of the subject matter can receive rows of training data, where each row comprises columns of values. The machine learning method can then use this data to predict one or more of the columns identified as one or more targets of prediction. Example machine learning systems include classifiers and regression systems. In a classifier, the targets are discrete; in a regression system, the targets are real-valued.

Some machine learning classifiers involve determining the frequency of occurrence of specific variable values possibly conditioned on other variable values. For example, f(aₓ, b_{y}, s|aₓ₋₁, b_{y-1}, s′) can be defined as f(b_{y}|aₓ, s, aₓ₋₁, b_{y-1}, s′)f(aₓ|s, aₓ₋₁, b_{y-1}, s′)f(s|aₓ₋₁, b_{y-1}, s′), where f(b_{y}|aₓ, s, aₓ₋₁, b_{y-1}, s′) is the frequency of b_{y} occurrence given aₓ, s, aₓ₋₁, b_{y-1}, s′, f(aₓ|s, aₓ₋₁, b_{y-1}, s′) is the frequency of aₓ occurrence given s, aₓ₋₁, b_{y-1}, s′ and f(s|aₓ₋₁, b_{y-1}, s′) is the frequency of s occurrence given aₓ₋₁, b_{y-1}, s′. In short, all of these functions can be learned as conditional probability tables.

Similarly, c(aₓ, b_{y}, s) can be defined as c(b_{y}|aₓ, s)c(aₓ|s)c(s), where c(b_{y}|aₓ, s) is the frequency of b_{y} given aₓ, s, c(aₓ|s) is the frequency of aₓ given s, and c(s) is the frequency of s. The term “frequency” used here can be viewed as synonymous with the term “probability.” Moreover, various probability distributions can be used to define these functions. For example, multivariate Gaussians can be used to define these probability functions through a mean vector and a covariance matrix, both of which can be determined from data.

The training data for f(b_{y}|aₓ, s, aₓ₋₁, b_{y-1}, s′) comprises rows in the form of aₓ, s, aₓ₋₁, b_{y-1}, s′ with the prediction target b_{y} for each row. The training data for f(aₓ|s, aₓ₋₁, b_{y-1}, s′) comprises rows in the form of s, aₓ₋₁, b_{y-1}, s′ with the prediction target aₓ. The training data for f(s|aₓ₋₁, b_{y-1}, s′) comprises rows in the form of aₓ₋₁, b_{y-1}, s′ with the targets. The training data for c(b_{y}|aₓ, s) comprises rows in the form of aₓ, s with the target b_{y}. The training data for c(aₓ|s) comprises rows in the form s with the target aₓ. The training data for c(s) comprises rows in the form s. All of these different forms of rows and their corresponding targets can be learned with various machine learning methods.

Multiple different initial models can be run to convergence, where convergence is defined as above. Embodiments of the subject matter can then select the best model among the initial models run to convergence based on determining the likelihood of the data given each of the converged models on a non-empty validation set of rows. This validation set can be based on splitting the original training data into two portions: one portion for training and another portion for validation.

The number of states can be determined by similarly reserving a validation set on which the likelihood can be evaluated. As the number of states increases, the likelihood will increase on this validation set until a peak point or a point of diminishing returns is reached. The number of states associated with this peak point can be chosen as the most likely number of states.

The preceding description is presented to enable any person skilled in the art to make and use the subject matter, and is provided in the context of a particular application and its requirements. Various modifications to the disclosed embodiments will be readily apparent to those skilled in the art, and the general principles defined herein may be applied to other embodiments and applications without departing from the spirit and scope of the subject matter. Thus, the subject matter is not limited to the embodiments shown, but is to be accorded the widest scope consistent with the principles and features disclosed herein.

Embodiments of the subject matter and the functional operations described in this specification can be implemented in digital electronic circuitry, in tangibly embodied computer software or firmware, in computer hardware, including the structures disclosed in this specification and their structural equivalents, or in combinations of one or more of them.

Embodiments of the subject matter described in this specification can be implemented as one or more computer programs, i.e., one or more modules of computer program instructions encoded on a tangible non-transitory program carrier for execution by, or to control the operation of data processing system.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment.

A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

Alternatively, or in addition, the program instructions can be encoded on an artificially generated propagated signal, e.g., a machine-generated electrical, optical, or electromagnetic signal, that is generated to encode information for transmission to a suitable receiver system for execution by a data processing system. The computer storage medium can be a machine-readable storage device, a machine-readable storage substrate, a random or serial access memory device, or a combination of one or more of them.

Computers suitable for the execution of a computer program include, by way of example, can be based on general or special purpose microprocessors or both, or any other kind of central processing unit. Generally, a central processing unit will receive instructions and data from a read only memory or a random-access memory or both. The essential elements of a computer are a central processing unit for performing or executing instructions and one or more memory devices for storing instructions and data.

A computer can also be distributed across multiple sites and interconnected by a communication network, executing one or more computer programs to perform functions by operating on input data and generating output.

A computer can also be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Generally, a computer will also include, or be operatively coupled to receive data from or transfer data to, or both, one or more mass storage devices for storing data, e.g., magnetic, magneto optical disks, or optical disks. However, a computer need not have such devices.

The term “data processing system’ encompasses all apparatus, devices, and machines for processing data, including by way of example a programmable processor, a computer, or multiple processors or computers.

For a system of one or more computers to be configured to perform particular operations or actions means that the system has installed on it in software, firmware, hardware, or a combination of them that in operation cause the system to perform the operations or actions. For one or more computer programs to be configured to perform particular operations or actions means that the one or more programs include instructions that, when executed by data processing system, cause the system to perform the operations or actions.

The processor and the memory can be supplemented by, or incorporated in, special purpose logic circuitry. More generally, the processes and logic flows can also be performed by and be implemented as special purpose logic circuitry, e.g., an FPGA (field programmable gate array) or an ASIC (application specific integrated circuit), a dedicated or shared processor that executes a particular software module or a piece of code at a particular time, and/or other programmable-logic devices now known or later developed. When the hardware modules or system are activated, they perform the methods and processes included within them.

The system can also include, in addition to hardware, code that creates an execution environment for the computer program in question, e.g., code that constitutes processor firmware, a protocol stack, a database management system, an operating system, or a combination of one or more of them.

The computer-readable storage medium includes, but is not limited to, volatile memory, non-volatile memory, magnetic and optical storage devices such as disk drives, magnetic tape, CDs (compact discs), DVDs (digital versatile discs or digital video discs), computer instruction signals embodied in a transmission medium (with or without a carrier wave upon which the signals are modulated), and other media capable of storing computer-readable media now known or later developed. For example, the transmission medium may include a communications network, such as a LAN, a WAN, or the Internet.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

The methods and processes described in the detailed description section can be embodied as code and/or data, which can be stored in a computer-readable storage medium as described above. When a computer system reads and executes the code and/or data stored on the computer-readable storage medium 120, the computer system performs the methods and processes embodied as data structures and code and stored within the computer-readable storage medium.

The components of the system can be interconnected by any form or medium of digital data communication, e.g., a communication network. Examples of communication networks include a local area network (“LAN”) and a wide area network (“WAN”), e.g., the Internet.

While this specification contains many specific implementation details, these should not be construed as limitations on the scope of any subject matter or of what may be claimed, but rather as descriptions of features that may be specific to particular embodiments of particular subject matters. Certain features that are described in this specification in the context of separate embodiments can also be implemented in combination in a single embodiment.

Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system modules and components in the embodiments described above should not be understood as requiring such separation in all embodiments, and it should be understood that the described program components and systems can generally be integrated together in a single software product or packaged into multiple software products.

The foregoing descriptions of embodiments of the subject matter have been presented only for purposes of illustration and description. They are not intended to be exhaustive or to limit the subject matter to the forms disclosed. Accordingly, many modifications and variations will be apparent to practitioners skilled in the art. Additionally, the above disclosure is not intended to limit the subject matter. The scope of the subject matter is defined by the appended claims.

What is claimed is:

1. A computer-implemented method for facilitating sequence-to-sequence translation comprising:
receiving an output b, a state s, a location x, a location y, a non-empty input sequence a, a non-empty set of outputs B, and a non-empty set of states S;
determining a maximum value over each element b′ in B and each element s′ in S based on a function of aₓ, b, s, aₓ₋₁, b′, s′ and a previously determined value based on b′, s′, x−1, and y−1; and
returning a result indicating the maximum value.

2. The method of claim 1, comprising:
determining the maximum value additionally based over each element b′ in B and each element s′ in S based on a function of aₓ, b, s, b′, s′ and a previously determined value based on b′, s′, x, and y−1.

3. The method of claim 1, comprising:
determining the maximum value additionally based over each elements' in S based on a function of aₓ, b, s, aₓ₋₁, s′ and a previously determined value based on b, s′, x−1, and y.

4. The method of claim 1,
wherein the function of aₓ, b, s, aₓ₋₁, b′, s′ is machine-learned from training data.

5. The method of claim 2,
wherein the function of aₓ, b, s, b′, s′ is machine-learned from training data.

6. The method of claim 3,
wherein the function of aₓ, b, s, aₓ₋₁, s′ is machine-learned from training data.

7. One or more non-transitory computer-readable storage media storing instructions that when executed by one or more computers cause the one or more computers to perform operations for facilitating sequence to sequence translation, comprising:
receiving an output b, a state s, a location x, a location y, a non-empty input sequence a, a non-empty set of outputs B, and a non-empty set of states S;
determining a maximum value over each element b′ in B and each element s′ in S based on a function of aₓ, b, s, aₓ₋₁, b′, s′ and a previously determined value based on b′, s′, x−1, and y−1; and
returning a result indicating the maximum value.

8. The one or more non-transitory computer-readable storage media of claim 7, comprising:
determining the maximum value additionally based over each element b′ in B and each element s′ in S based on a function of aₓ, b, s, b′, s′ and a previously determined value based on b′, s′, x, and y−1.

9. The one or more non-transitory computer-readable storage media of claim 7, comprising:
determining the maximum value additionally based over each elements' in S based on a function of aₓ, b, s, aₓ₋₁, s′ and a previously determined value based on b, s′, x−1, and y.

10. The one or more non-transitory computer-readable storage media of claim 7,
wherein the function of aₓ, b, s, aₓ₋₁, b′, s′ is machine-learned from training data.

11. The one or more non-transitory computer-readable storage media of claim 8,
wherein the function of aₓ, b, s, b′, s′ is machine learned from training data.

12. The one or more non-transitory computer-readable storage media of claim 9,
wherein the function of aₓ, b, s, aₓ₋₁, s′ is machine-learned from training data.

13. A system comprising one or more computers and one or more storage devices storing instructions that when executed by the one or more computers cause the one or more computers to perform operations for facilitating compression, comprising:
receiving an output b, a state s, a location x, a location y, a non-empty input sequence a, a non-empty set of outputs B, and a non-empty set of states S;
determining a maximum value over each element b′ in B and each element s′ in S based on a function of aₓ, b, s, aₓ₋₁, b′, s′ and a previously determined value based on b′, s′, x−1, and y−1; and
returning a result indicating the maximum value.

14. The system of claim 13, comprising:
determining the maximum value additionally based over each element b′ in B and each element s′ in S based on a function of aₓ, b, s, b′, s′ and a previously determined value based on b′, s′, x, and y−1.

15. The system of claim 13, comprising:
determining the maximum value additionally based over each element s′ in S based on a function of aₓ, b, s, aₓ₋₁, s′ and a previously determined value based on b, s′, x−1, and y.

16. The system of claim 13,
wherein the function of aₓ, b, s, aₓ₋₁, b′, s′ is machine-learned from training data.

17. The system of claim 14,
wherein the function of aₓ, b, s, b′, s′ is machine-learned from training data.

18. The system of claim 15,
wherein the function of aₓ, b, s, aₓ₋₁, s′ is machine-learned from training data.
